(19) United States
(12) Patent Application Publication
(10) Pub. No.: US 2025/0237816 A1
(43) Pub. Date: Jul. 24, 2025

(54) RING RESONATOR FILTER BASED WDM RECEIVER AND OPERATING METHOD THEREOF

(71) Applicant: UIF (University Industry Foundation), Yonsei University, Seoul (KR)

(72) Inventors: Woo Young CHOI, Seoul (KR); Hyun Kyu KIM, Suwon-si (KR); Jae Ho LEE, Seoul (KR)

(21) Appl. No.: 19/005,721

(22) Filed: Dec. 30, 2024

(30) Foreign Application Priority Data
Jan. 22, 2024 (KR) 10-2024-0009585
Dec. 27, 2024 (KR) 10-2024-0199317

(51) Int. Cl. G02B 6/293; G02F 1/01; G02F 1/313; H04B 10/60; H04J 14/02

(52) U.S. Cl. CPC G02B 6/29343; G02F 1/0147; G02F 1/313; H04B 10/60; H04J 14/02

(57) ABSTRACT

A WDM receiver based on a ring resonator according to the present disclosure may include a plurality of ring resonator filters configured to receive a WDM optical signal, and each configured to have a heater; a plurality of photodetectors configured to convert the optical signal into a current; and a temperature controller configured to obtain a monitoring voltage corresponding to an output current of corresponding photodetector from each of the plurality of transimpedance amplifying circuits, and control a heater voltage of each of the plurality of ring resonator filters according to the monitoring voltage.

A WDM transmitter based on a ring resonator according to the present disclosure may include a plurality of optical modulators configured to output a WDM optical signal and each configured to have a heater; a plurality of photodetectors configured to convert the optical signal into a current; and a temperature controller configured to control a heater voltage of the heater of the plurality of optical modulators according to the monitoring voltage corresponding to an output current of the photodetector.

### TECHNICAL FIELD

The present disclosure relates to a WDM transmitter based on a ring resonator, a WDM receiver based on a ring resonator, and an operating method thereof.

### BACKGROUND ART OF THE INVENTION

Wavelength Division Multiplexing (WDM) is one of optical transmission systems, which refers to bundling multiple channels with different wavelengths of light and transmitting them through a single optical fiber. Arrayed Waveguide Grating (AWG) and Mach-Zehnder Interferometer (MZI) have been widely used as wavelength filters necessary for WDM receivers. However, such filters are relatively large, so it is difficult to achieve the required bandwidth density. On the other hand, Ring Resonator Filter (RRF) is spotlighted as a wavelength filter of the WDM receiver due to the very small size. However, since the characteristics of the RRF depend heavily on the manufacturing process variation and temperature, an electronic controller is required to ensure and maintain the desired filtering characteristics of the RRF for temperature changes.

A general technique for this is to control the temperature of the RRF using an on-chip heater. For example, a look-up table can be used for the temperature control, but it is not an appropriate solution when the WDM receiver is expected to face wide environmental changes. There is a temperature control technique based on the closed-loop feedback control of the on-chip heater, which enables precise control of the RRF, but depends on independent closed-loop feedback for each WDM channel, so initial calibration must be carried out sequentially, which can lead to a long calibration time.

### CONTENTS OF INVENTION

### Technical Problem

The technical problem to be solved by the present disclosure is to provide a ring resonator-based WDM transmitter and a ring resonator-based WDM receiver capable of calibrating and maintaining WDM channels on the whole, further capable of reconfiguring the WDM channels, and capable of maintaining an optimal state under any temperature change, and an operating method thereof.

The technical problem to be solved of the present disclosure is not limited to the above-mentioned problems, and other technical problems not mentioned may be clearly understood by those skilled in the art from the following description.

### Technical Solution

A WDM receiver based on a ring resonator according to the present disclosure for solving the technical problem includes a plurality of ring resonator filters (RRFs) configured to receive a WDM optical signal, and each configured to have a heater; a plurality of photodetectors (PDs) each configured to be connected to an output of each of the plurality of ring resonator filters and convert the optical signal into a current; a plurality of transimpedance amplifying circuits each configured to be connected to an output of each of the plurality of photodetectors; and a temperature controller configured to obtain a monitoring voltage corresponding to an output current of corresponding photodetector from each of the plurality of transimpedance amplifying circuits, and control a heater voltage of each of the plurality of ring resonator filters according to the monitoring voltage.

In a first mode, the temperature controller may obtain the heater voltages when peaks of the monitoring voltages are generated while sweeping the heater voltage of one of the plurality of ring resonator filters, and adjust the corresponding heater voltage depending on the corresponding monitoring voltage while changing the corresponding heater voltage based on each obtained heater voltage for each of the remaining ring resonator filters in a second mode.

The monitoring voltage may correspond to a DC component of the output current.

Each of the transimpedance amplifying circuits may include a DC offset-compensating circuit configured to compensate for a DC offset of a transimpedance amplifier, and the monitoring voltage may be obtained from the DC offset-compensating circuit.

The monitoring voltage may be obtained by detecting an output of an operational amplifier provided in the DC offset-compensating circuit.

In the second mode, the temperature controller may change the heater voltage, and compare the monitoring voltage before and after the change, and increase or decrease the heater voltage according to the comparison result.

In the second mode, the temperature controller may increase the heater voltage if the monitoring voltage increases when the heater voltage is increased, and decrease the heater voltage if the monitoring voltage decreases when the heater voltage is increased.

In the second mode, the temperature controller may decrease the heater voltage if the monitoring voltage increases when the heater voltage is decreased, and increase the heater voltage if the monitoring voltage decreases when the heater voltage is decreased.

In a method for operating a WDM receiver based on a ring resonator according to the present disclosure to solve the technical problem, the ring resonator-based WDM receiver may include a plurality of ring resonator filters configured to receive a multi-wavelength optical signal and each configured to have a heater; a plurality of photodetectors each configured to be connected to an output of each of the plurality of ring resonator filters and convert the optical signal into a current; a plurality of transimpedance amplifying circuits each configured to be connected to an output of each of the plurality of photodetectors; and a temperature controller configured to obtain a monitoring voltage corresponding to an output current of corresponding photodetector from each of the plurality of transimpedance amplifying circuits, and control a heater voltage of each of the plurality of ring resonator filters according to the monitoring voltage, and the method may include (a) obtaining the heater voltages when peaks of the monitoring voltages are generated while sweeping the heater voltage of one of the plurality of ring resonator filters in a first mode; and (b) adjusting the corresponding heater voltage depending on the corresponding monitoring voltage while changing the corresponding heater voltage based on each obtained heater voltages for each of the remaining ring resonator filters in a second mode.

The monitoring voltage may correspond to a DC component of the output current.

Each of the transimpedance amplifying circuits may include a DC offset-compensating circuit configured to compensate for a DC offset of a transimpedance amplifier, and the monitoring voltage may be obtained from the DC offset-compensating circuit.

The monitoring voltage may be obtained by detecting an output of an operational amplifier provided in the DC offset-compensating circuit.

The step (b) may include changing the heater voltage, and comparing the monitoring voltage before and after the change, and increasing or decreasing the heater voltage according to the comparison result.

The step (b) may include increasing the heater voltage if the monitoring voltage increases when the heater voltage is increased, and decreasing the heater voltage if the monitoring voltage decreases when the heater voltage is increased.

The step (b) may include decreasing the heater voltage if the monitoring voltage increases when the heater voltage is decreased, and increasing the heater voltage if the monitoring voltage decreases when the heater voltage is decreased.

A WDM transmitter based on a ring resonator according to the present disclosure for solving the technical problem includes a plurality of optical modulators configured to output a WDM optical signal and each configured to have a heater; a plurality of photodetectors each configured to be connected to an output of each of the plurality of optical modulators and convert the optical signal into a current; a plurality of optical modulator drivers each configured to be connected to an input of each of the plurality of photodetectors; and a temperature controller configured to obtain a monitoring voltage corresponding to an output current of the photodetector and control a heater voltage of the heater of each of the plurality of optical modulators according to the monitoring voltage.

The temperature controller may obtain the heater voltages when peaks of the monitoring voltages are generated while sweeping the heater voltages of the plurality of optical modulators in a first mode, and adjust the corresponding heater voltage depending on the corresponding monitoring voltage while changing the corresponding heater voltage based on each obtained heater voltage for each of the optical modulators in a second mode.

In the second mode, the temperature controller may change the heater voltage, and compare the monitoring voltage before and after the change, and increase or decrease the heater voltage according to the comparison result.

In the second mode, the temperature controller may increase the heater voltage if the monitoring voltage increases when the heater voltage is increased, and decrease the heater voltage if the monitoring voltage decreases when the heater voltage is increased.

In the second mode, the temperature controller may decrease the heater voltage if the monitoring voltage increases when the heater voltage is decreased, and increase the heater voltage if the monitoring voltage decreases when the heater voltage is decreased.

### Effects of the Invention

According to the present disclosure described above, it is possible to calibrate and maintain WDM channels on the whole, further reconfigure the WDM channels, and maintain an optimal state under any temperature change.

The effects of the present disclosure are not limited to the above-mentioned effects, and other effects not mentioned may be clearly understood by those skilled in the art from the following description.

### BRIEF DESCRIPTION OF THE DRAWINGS

FIG. 1 shows a structure of a WDM receiver based on a ring resonator according to an embodiment of the present disclosure.

FIG. 2 shows transmission characteristics of a ring resonator filter at an output of a bus waveguide.

FIG. 3 shows filter characteristics of a single ring resonator filter at a drop port.

FIG. 4 shows a temperature change and a resonance wavelength shift according to various heater powers of a ring resonator filter.

FIG. 5 shows a specific structure of one WDM channel of a ring resonator-based WDM receiver according to an embodiment of the present disclosure.

FIG. 6 shows a flowchart of a method for operating a WDM receiver based on a ring resonator according to an embodiment of the present disclosure.

FIG. 7 shows a flowchart of a specific operation of step S620 in FIG. 6.

FIG. 8A shows an operation of the scan mode.

FIG. 8B shows an operation of the dither-and-track mode.

FIG. 8C shows a heater voltage and a monitoring voltage in a scan mode and dither-and-track mode of the WDM receiver of the present disclosure.

FIG. 9 shows a structure of a ring resonator-based WDM transmitter according to an embodiment of the present disclosure.

FIG. 10 shows a voltage in a scan mode and a dither-and-track mode of the WDM transmitter of the present disclosure.

### DETAILED DESCRIPTION FOR IMPLEMENT THE INVENTION

Hereinafter, preferred embodiments of the present disclosure will be described in detail with reference to the drawings. In the following description and the accompanying drawings, substantially the same components are represented by the same reference numerals, and a duplicate description will be omitted. In addition, in describing the present disclosure, if it is judged that the detailed description of the related known function or configuration may unnecessarily obscure the gist of the present disclosure, the detailed description thereof will be omitted.

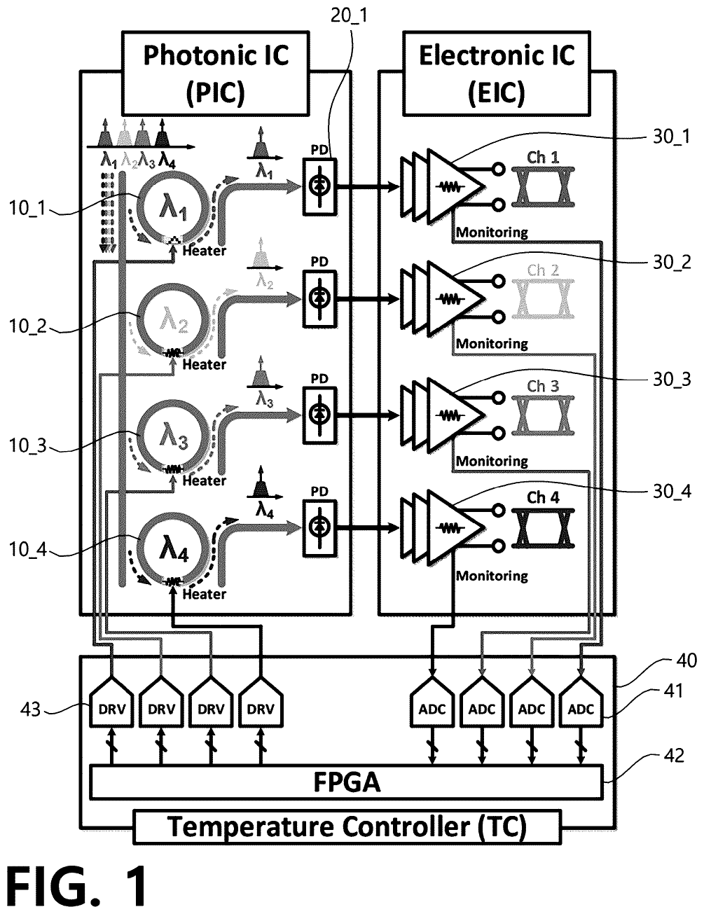

FIG. 1 shows a structure of a WDM receiver based on a ring resonator according to an embodiment of the present disclosure.

The ring resonator-based WDM receiver according to an embodiment of the present disclosure includes a plurality of ring resonator filters 10_1, 10_2, 10_3, and 10_4, a plurality of photodetectors 20_1, 20_2, 20_3, and 20_4, a plurality of transimpedance amplifying circuits 30_1, 30_2, 30_3, and 30_4, and a temperature controller 40. For the convenience of explanation, the embodiment of the present disclosure illustrates a 4-channel WDM receiver is described, in which the ring resonator filters, the photodetectors, and the plurality of transimpedance amplifying circuits are each composed of 4 units, as an example, but the WDM receiver has any wavelength channel, so that the ring resonator filters, photodetectors, and the plurality of transimpedance amplifying circuits may be implemented in any number corresponding to the number of wavelength channels.

The ring resonator filters 10_1, 10_2, 10_3, and 10_4 and photodetectors 20_1, 20_2, 20_3, and 20_4 may be implemented in an optical integrated circuit (Photonic IC), and transimpedance amplifying circuits 30_1, 30_2, 30_3, and 30_4 may be implemented in an electronic integrated circuit (Electronic IC). The ring resonator filters 10_1, 10_2, 10_3, and 10_4 share a single bus waveguide and receive a WDM optical signal through the single bus waveguide. Each of the ring resonator filters 10_1, 10_2, 10_3, and 10_4 includes a heater adjustable in temperature according to a heater voltage. The ring resonator filters 10_1, 10_2, 10_3, and 10_4 may be implemented as, for example, a silicon rip waveguide.

The photodetectors 20_1, 20_2, 20_3, and 20_4 are connected to the outputs (drop ports) of the ring resonator filters 10_1, 10_2, 10_3, and 10_4 respectively and convert an optical signal output from the corresponding ring resonator filter into a current signal. The photodetectors 20_1, 20_2, 20_3, and 20_4 may be implemented as photodiodes, for example.

Each of the transimpedance amplifying circuits 30_1, 30_2, 30_3, and 30_4 amplify the current signal of the corresponding channel output from the photodetector of the corresponding ring resonator filter, respectively. Each of transimpedance amplifying circuits 30_1, 30_2, 30_3, and 30_4 may be implemented as, for example, a CMOS transimpedance amplifier.

The temperature controller 40 obtains each monitoring voltage corresponding to each output current of each photodetector 20_1, 20_2, 20_3, and 20_4 from each transimpedance amplifying circuit 30_1, 30_2, 30_3, and 30_4, and controls each heater voltage of each heater of each ring resonator filter 10_1, 10_2, 10_3, and 10_4 according to each corresponding monitoring voltage. The temperature controller 40 may include ADCs 41 configured to sample each monitoring voltage obtained from each transimpedance amplifying circuit 30_1, 30_2, 30_3, and 30_4 and convert it into each digital value, a heater voltage determiner 42 configured to determine each heater voltage required for each ring resonator filter 10_1, 10_2, 10_3, and 10_4 according to each digital value of each monitoring voltage, and DAC-based heater drivers 43 configured to convert each determined heater voltage into each analog value and transmit it to each corresponding heater.

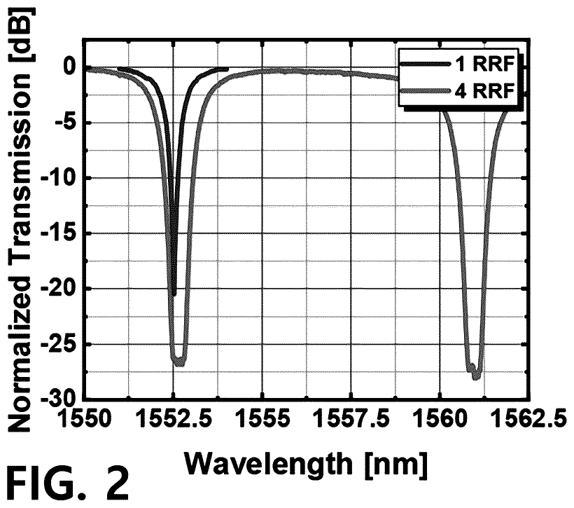

FIG. 2 shows transmission characteristics of a ring resonator filter at an output of a bus waveguide. The red line of FIG. 2 shows each transmission characteristic of the four ring resonator filters at the output of the bus waveguide when an optical signal having multi-wavelengths are introduced without heating the heater. All the ring resonator filters are designed to have the same shape, but there is a slight difference in resonance wavelength due to differences in the manufacturing process. Therefore, it may be seen that the measured transmission peak (red line) is wider than the resonance peak of one ring resonator filter indicated by the blue line for comparison.

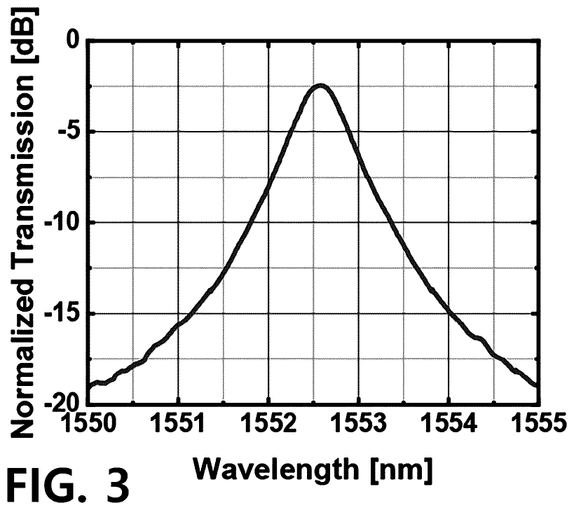

FIG. 3 shows filter characteristics of a single ring resonator filter at a drop port. Referring to FIG. 3, the Q-factor is approximately 2200.

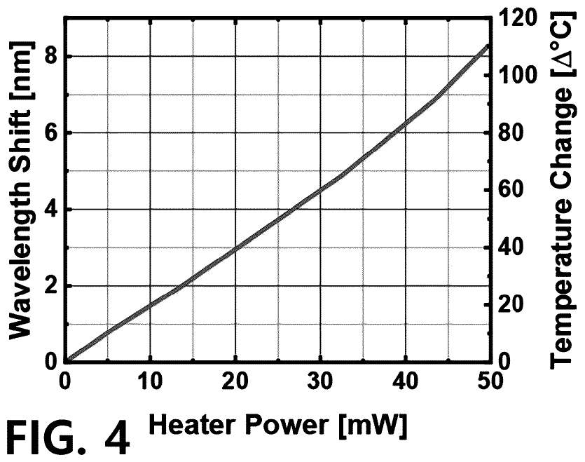

FIG. 4 shows a temperature change and a resonance wavelength shift according to various heater powers of a ring resonator filter. Referring to FIG. 4, it may be seen that the temperature and the resonance wavelength increase as the heater power increases.

In an embodiment of the present disclosure, the temperature controller 40 determines the heater voltage required for each ring resonator filter 10_1, 10_2, 10_3, and 10_4 of each WDM channel through two modes, that is, a scan mode and a dither-and-track mode.

While the WDN optical signal is input to a bus waveguide, the temperature controller 40 first performs the scan mode. In the scan mode, the temperature controller 40 is configured to sweep the heater voltage of any one of the ring resonator filters 10_1, 10_2, 10_3, and 10_4. At this time, the monitoring voltage shows peaks corresponding to the number of WDM channels. The temperature controller 40 is configured to obtain and store the heater voltages when the peaks of the monitoring voltage are generated while sweeping the heater voltage of the ring resonator filter 10_1. In this time, the obtained heater voltages as many as the number of WDM channels correspond to heater voltages required for each ring resonator filter under the operating condition of the WDM receiver, assuming that all the ring resonator filters 10_1, 10_2, 10_3, and 10_4 have the same characteristics.

However, due to the variation in the ring resonator generated in the manufacturing process, the heater voltage value found in one ring resonator filter through the scan mode may not match the heater voltage value required for the ring resonator filter of another WDM channel. Therefore, after completing the scan mode, the temperature controller 40 may correct the error through the dither-and-track mode. In the dither-and-track mode, the temperature controller 40 is configured to change a corresponding heater voltage based on each heater voltage obtained in the scan mode for each of the remaining ring resonator filters 10_2, 10_3, and 10_4 and adjust the corresponding heater voltage according to the corresponding monitoring voltage. Specifically, the temperature controller 40 intentionally slightly changes the heater voltage and compares the monitoring voltage before and after the change to determine whether to increase or decrease the heater voltage based on the comparison result.

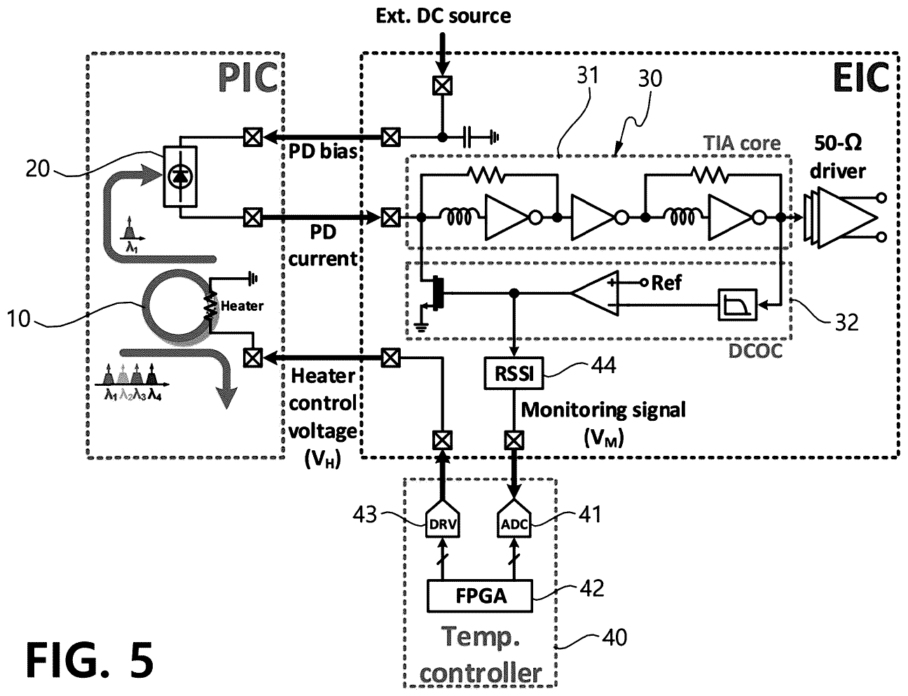

FIG. 5 shows a specific structure of one WDM channel of a ring resonator-based WDM receiver according to an embodiment of the present disclosure. FIG. 5 shows, for convenience, a ring resonator filter 10, a photodetector 20, and a transimpedance amplifying circuit 30 corresponding to one WDN channel.

The transimpedance amplifying circuit 30 generally includes a transimpedance amplifier core 31 based on an inverter, and a DC offset-compensating circuit 32 configured to compensate for DC offset. The DC offset-compensating circuit 32 consists of a loop including a low-pass filter, an operational amplifier, and a transistor for a DC current sink. The operational amplifier of the DC offset-compensating circuit 32 outputs a voltage corresponding to the DC component of an output current of the photodetector 20. Therefore, in an embodiment of the present disclosure, by detecting the output of the operational amplifier in the DC offset-compensating circuit 32 using a voltage sensor 44, the monitoring voltage VM corresponding to the DC component of the output current of the photodetector 20 may be obtained. The ADC 41 is configured to convert the monitoring voltage VM into a digital value, and the heater voltage determiner 42 is configured to determine the heater voltage VH required for the ring resonator filter 10 according to the monitoring voltage VM. The heater voltage determiner 42 may be implemented as an FPGA. The heater driver 43 is configured to convert the heater voltage VH into an analog value and transmit it to the heater of the resonator filter 10.

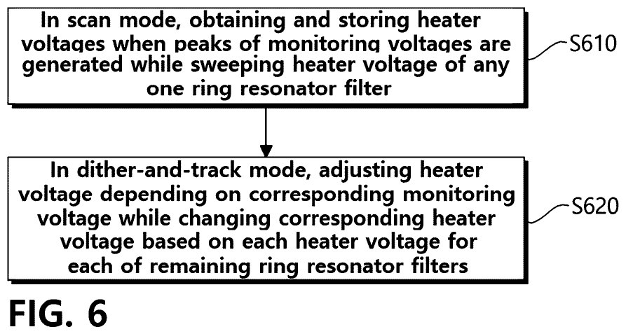

FIG. 6 shows a flowchart of a method for operating a WDM receiver based on a ring resonator according to an embodiment of the present disclosure.

In step S610, the temperature controller 40, in a scan mode, obtains and stores heater voltages VH1, VH2, VH3, and VH4 when peaks of the monitoring voltages VM are generated while sweeping the heater voltage of any one ring resonator filter 10_1.

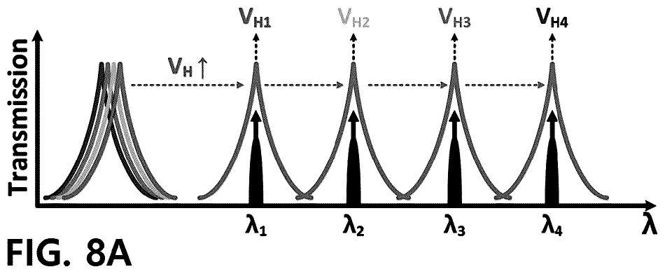

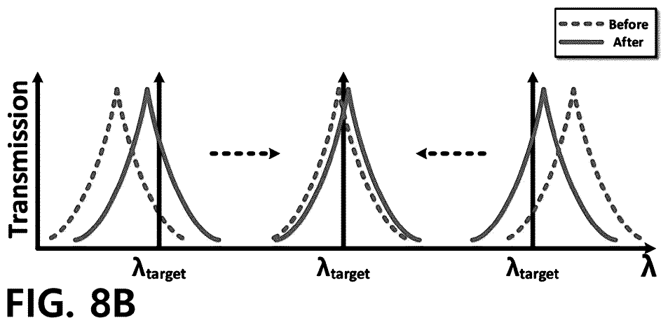

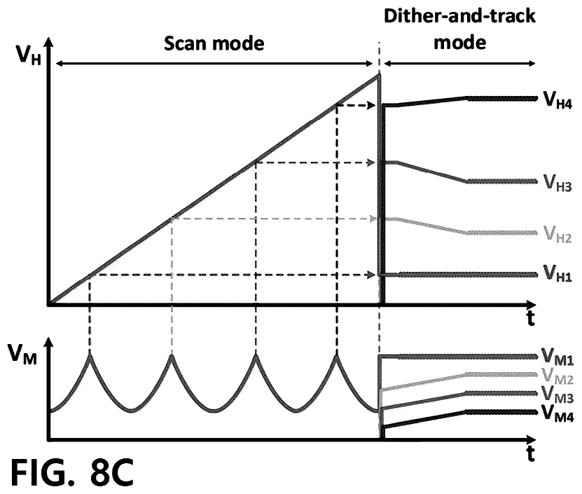

FIG. 8A shows an operation of the scan mode. While an optical signal having four different wavelengths is introduced into the WDM receiver, the heater voltages are swept for the one ring resonator filter 10_1. Through this scanning, four peaks are obtained in the monitoring voltage VM for four wavelengths λ1, λ2, λ3, and λ4. Each of the four heater voltages VH1, VH2, VH3, and VH4 configured to generate the peaks of the monitoring voltage VM corresponds to a heater voltage value required for each of ring resonator filters 10_1, 10_2, 10_3, and 10_4 for a resonance condition, assuming that all the four ring resonator filters have the same characteristics. This heater voltage value is stored and applied first to each ring resonator filter 10_1, 10_2, 10_3, and 10_4. However, due to the difference in the manufacturing process, the heater voltage value determined in the scan mode may not match the heater voltage value necessary for each ring resonator filter. Therefore, fine adjustment of the heater voltage is required, which is performed through dither-and-track mode.

Referring again to FIG. 6, step S620 is the dither-and-track mode, in which the temperature controller 40 adjusts the heater voltage according to the corresponding monitoring voltage while changing the corresponding heater voltage based on each heater voltage obtained in the scan mode for each of the remaining ring resonator filters 10_2, 10_3, and 10_4.

FIG. 8B shows an operation of the dither-and-track mode. In the dither-and-track mode, the temperature controller 40 intentionally changes the heater voltage VH slightly and compares the monitoring voltage VM values before and after the change. Then, the temperature controller 40 determines whether to increase or decrease the heater voltage VH in order to bring the resonant wavelength of the ring resonator to the desired value.

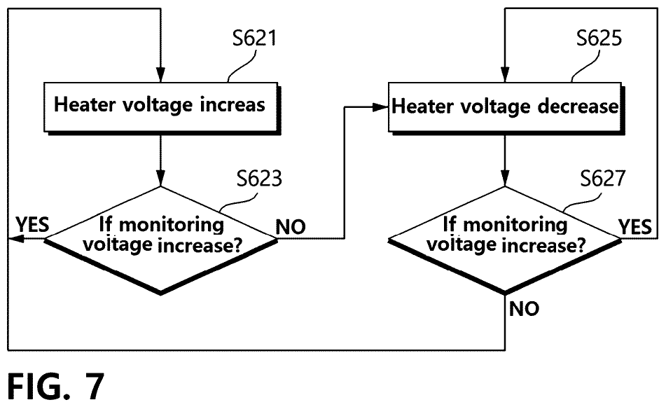

FIG. 7 shows a flowchart of a specific operation of step S620 in FIG. 6. The heater voltage VH is increased (step S621), if the monitoring voltage VM increases (i.e., VM,after>VM,before) when the heater voltage VH increases (step S623), the heater voltage VH is increased again (step S621). If the monitoring voltage VM decreases (i.e., VM,after<VM,before) when the heater voltage VH increases (step S623), the heater voltage VH is decreased (step S625). If the monitoring voltage VM increases (i.e., VM,after>VM,before) when the heater voltage VH decreases (step S627), the heater voltage VH is decreased again (step S625). If the monitoring voltage VM decreases (i.e., VM,after<VM,before) when the heater voltage VH decreases (step S627), the heater voltage is increased (step S621). The amount of dithering (increase or decrease) may be made as small as possible so as not to significantly affect the performance of the WDM receiver.

FIG. 8C shows a heater voltage and a monitoring voltage in a scan mode and dither-and-track mode. As shown in FIG. 8C, the heater voltages VH1, VH2, VH3, and VH4 may be finely adjusted for each of the ring resonator filters.

Such dither-and-track mode may be continuously performed to compensate for the influence of temperature changes in the environment. In addition, since the heater voltage value for each ring resonator filter is approximately determined and stored through the scan mode, the temperature controller 40 may reconfigure the WDM receiver channel by applying the required heater voltage value using this information.

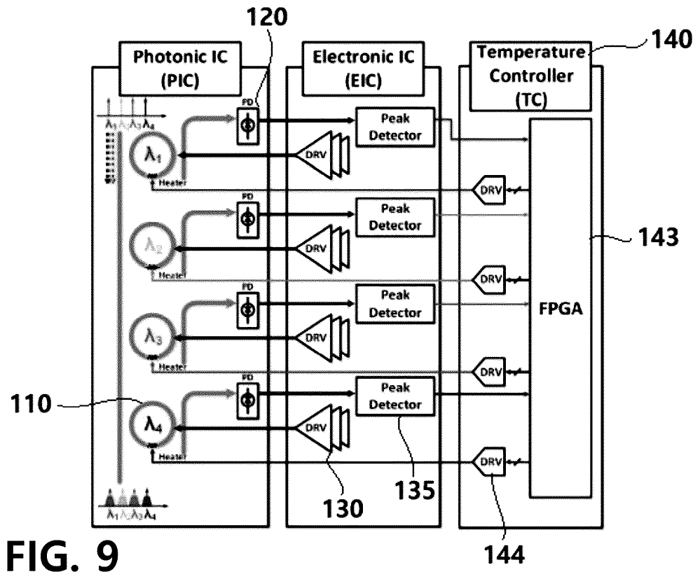

FIG. 9 shows a structure of a ring resonator-based WDM transmitter according to an embodiment of the present disclosure.

The ring resonator-based WDM transmitter according to an embodiment of the present disclosure includes a plurality of optical modulators 110, a plurality of photodetectors 120, a plurality of optical modulator drivers 130, a plurality of amplitude detectors 135 and a temperature controller 140. The WDM transmitter according to the embodiment of the present disclosure has an arbitrary channel, and the optical modulator 110, the photodetector 120, the optical modulator driver 130, and the amplitude detector 135 may be implemented in any number corresponding to the number of wavelength channels.

A plurality of optical modulator drivers 130 convert data signals (electrical signals) applied from a plurality of channels into optical signals of a plurality of wavelengths and output the optical signals to a plurality of optical modulators 110.

The optical modulator 110 includes a heater capable of adjusting a temperature according to each heater voltage. The optical modulator 110 may be implemented as, for example, a silicon rip waveguide.

The photodetector 120 is connected to each input terminal of the optical modulators 110 to convert the optical signal output from the corresponding optical modulator 110 into an electrical signal. The photodetector 120 may be implemented as, for example, a photodiode.

The temperature controller 140 controls the heater voltage of each heater of the optical modulator 110 based on the electrical signal output from the photodetector 120.

The amplitude detector 135 is configured to receive an electrical signal (current) for the optical signal output from the photodetector 120, and detect an optical modulation amplitude (OMA) based on the electrical signal.

Referring to FIG. 9, the temperature controller 140 includes a temperature-controlling unit 143 and a heater-controlling unit 144.

The heater-controlling unit 144 receives a heater control code from the temperature-controlling unit 143 and generates a heater control voltage for controlling the operation of the heater provided in the optical modulator 110 based on the heater control code. The heater-controlling unit 144 transmits the generated heater control voltage to the heater to adjust a temperature of the optical modulator 110.

The amplitude detector 135 is configured to receive an electrical signal (current) for the optical signal output from the photodetector 120, and detect an optical modulation amplitude (OMA) based on the electrical signal.

The amplitude detector 135 outputs a detection signal corresponding to the detection result of the optical modulation amplitude to the temperature-controlling unit 143. The amplitude detector 135 outputs a detection signal corresponding to a detection result having the maximum value of the optical modulation amplitude (OMA) to the temperature-controlling unit 143.

Specifically, the amplitude detector 135 receives an electrical signal (current) for an optical signal output from the photodetector 120, and detects an RMS voltage proportional to the RMS of the electrical signal.

The amplitude detector 135 is configured to detect a slope based on the detection result for the RMS voltage and transmit a detection signal in which the optical modulation amplitude (OMA) has a maximum value to the temperature controller 143. The temperature-controlling unit 143 may select a heater control voltage or heater control code when the optical modulation amplitude (OMA) has the maximum value based on the detection signal.

The temperature-controlling unit 143 obtains the detection signal from the amplitude detector 135 and generates a heater control code based on the detection signal.

The temperature-controlling unit 143 transmits the heater control code to the heater-controlling unit 144 to generate the heater control voltage corresponding to the heater control code, thereby controlling the operation of the heater to adjust the temperature of the optical modulator 110.

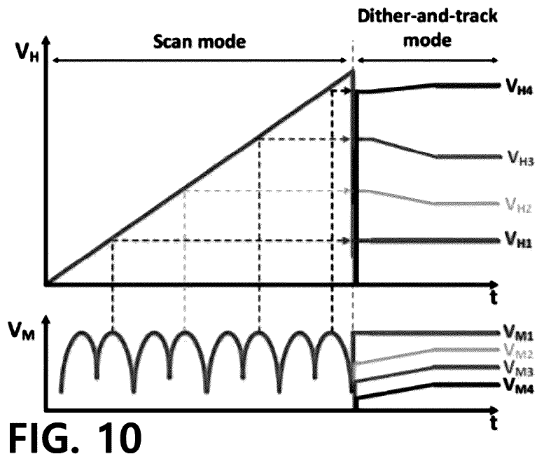

FIG. 10 shows a voltage in a scan mode and a dither-and-track mode of the WDM transmitter of the present disclosure.

In an embodiment of the present disclosure, the temperature-controlling unit 143 determines the heater voltage required for the optical modulator 110 of each WDM channel through two modes, that is, a scan mode and a dither-and-track mode.

While the WDM optical signal is output, the temperature-controlling unit 143 first performs the scan mode. In the scan mode, the temperature-controlling unit 143 sweeps the heater voltage of the optical modulator 110. At this time, a monitoring voltage shows a first peak and a second peak. The temperature-controlling unit 143 obtains and stores a heater voltage when the peaks of the monitoring voltage are generated while sweeping the heater voltage of the optical modulator 110.

That is, the temperature-controlling unit 143 operates in the scan mode during an initial operation of the optical modulator 110. In the scan mode, the temperature-controlling unit 143 selects a heater control voltage having a maximum value of the light modulation amplitude (OMA) corresponding to the second peak with stability, and transmits the generated heater control code to the heater-controlling unit 144 to control the heater with the selected heater control voltage.

However, due to the variation of the ring resonator generated in the manufacturing process, an error may occur in the heater voltage value found in the optical modulator 110 through the scan mode. Accordingly, after completing the scan mode, the temperature-controlling unit 143 corrects the error through the dither-and-track mode. In the dither-and-track mode, the temperature-controlling unit 143 adjusts the heater voltage according to the monitored voltage while changing the corresponding heater voltage based on each heater voltage obtained in the scan mode for each of the optical modulators 110. Specifically, the temperature-controlling unit 143 intentionally changes the heater voltage slightly and compares the monitoring voltage before and after the change and determines whether to increase or decrease the heater voltage according to the comparison result.

Specifically, the temperature-controlling unit 143 increases the heater voltage and increases the heater voltage again if the monitoring voltage increases when the heater voltage is increased. If the monitoring voltage decreases when the heater voltage is increased, the temperature-controlling unit 143 decreases the heater voltage.

In addition, when the monitored voltage increases when the heater voltage is decreased, the temperature-controlling unit 143 decreases the heater voltage again. If the monitoring voltage decreases when the heater voltage is decreased, the temperature-controlling unit 143 increases the heater voltage. The amount of dithering (increase or decrease) may be made as small as possible so as to not significantly affect the performance of the WDM transmitter.

As described above, the heater voltage may be finely adjusted for each optical modulator 110.

The dither-and-track mode may be continuously performed to compensate for the influence of the temperature change in the environment. In addition, since the heater voltage value for each optical modulator 110 is approximately determined and stored through the scan mode, the temperature-controlling unit 143 may reconfigure the WDM transmitter channel by applying the required heater voltage value using this information.

A device according to embodiments of the present disclosure may include a processor, a memory for storing and executing program data, a permanent storage such as a disk drive, a communication port for communicating with an external device, a user interface device such as a touch panel, a key, a button, and the like. Methods implemented by software modules or algorithms may be stored on a computer-readable recording medium as executable computer-readable codes or program instructions on the processor. Here, the computer-readable recording medium includes a magnetic storage medium (e.g., read-only memory (ROM), random-access memory (RAM), floppy disk, and hard disk), and an optical readable medium (e.g., compact disc read-only memory (CD-ROM) and digital versatile disc (DVD))). The computer-readable recording medium is distributed in computer systems connected through a network, and computer-readable codes can be stored and executed in a distributed manner. The medium can be read by a computer, stored in a memory, and executed by a processor.

Embodiments of the present disclosure may be represented by functional block configurations and various processing steps. These functional blocks may be implemented by various numbers of hardware and/or software configurations that execute specific functions. For example, embodiments may employ integrated circuit configurations such as memory, processing, logic, and look-up tables that can execute various functions by controlling one or more microprocessors or other control devices. Similar to the fact that the components of the present disclosure can be executed by software programming or software elements, embodiments may be implemented by programming or scripting languages such as C, C++, Java, and assembler including various algorithms implemented by a combination of data structures, processes, routines, or other programming configurations. Functional aspects may be implemented by algorithms that run on one or more processors. In addition, embodiments may employ conventional techniques for electronic environment setting, signal processing, and/or data processing. The terms “mechanism”, “element”, “means”, and “configuration” may be widely used, and are not limited to mechanical and physical configurations. The term may include a meaning of a series of routines of software in association with a processor or the like.

The specific execution described in the embodiments is an embodiment, and is not limiting the scope of the embodiments in any way. For simplicity, description of conventional electronic configurations, control systems, software, and other functional aspects of the systems may be omitted. In addition, the connection or connecting members of lines between the components shown in the drawings are exemplified by functional connections and/or physical or circuit connections, and may be represented as a variety of functional connections, physical connections, or circuit connections that may be replaced or added in an actual device. In addition, unless specifically mentioned, such as “essential,” “importantly,” and the like, they may not be necessary for the application of the present disclosure.

Hereinafter, the present disclosure has been described based on preferred embodiments thereof. One of ordinary skill in the art to which the present disclosure pertains can understand that the present disclosure may be embodied in a modified form without departing from the essential characteristics of the present disclosure. Therefore, the disclosed embodiments should be considered from a description perspective rather than a limiting perspective. The scope of the present disclosure is not shown in the above description but in the claims, and all differences within the equivalent range should be interpreted as being included in the present disclosure.

1. A WDM receiver based on a ring resonator, comprising:
a plurality of ring resonator filters (RRFs) configured to receive a WDM optical signal, and each configured to have a heater;
a plurality of photodetectors (PDs) each configured to be connected to an output of each of the plurality of ring resonator filters and convert the optical signal into a current;
a plurality of transimpedance amplifying circuits each configured to be connected to an output of each of the plurality of photodetectors; and
a temperature controller configured to obtain a monitoring voltage corresponding to an output current of corresponding photodetector from each of the plurality of transimpedance amplifying circuits, and control a heater voltage of each of the plurality of ring resonator filters according to the monitoring voltage.

2. The WDM receiver of claim 1, wherein the temperature controller is configured to:
obtain the heater voltages when peaks of the monitoring voltages are generated while sweeping the heater voltage of one of the plurality of ring resonator filters in a first mode, and
adjust the corresponding heater voltage depending on the corresponding monitoring voltage while changing the corresponding heater voltage based on each obtained heater voltage for each of the remaining ring resonator filters in a second mode.

3. The WDM receiver of claim 2, wherein the monitoring voltage is configured to correspond to a DC component of the output current.

4. The WDM receiver of claim 3, wherein each of the transimpedance amplifying circuits includes a DC offset-compensating circuit configured to compensate for a DC offset of a transimpedance amplifier, and the monitoring voltage is obtained from the DC offset-compensating circuit.

5. The WDM receiver of claim 4, wherein the monitoring voltage is obtained by detecting an output of an operational amplifier provided in the DC offset-compensating circuit.

6. The WDM receiver of claim 2, wherein the temperature controller, in the second mode, is configured to change the heater voltage, and compare the monitoring voltage before and after the change, and increase or decrease the heater voltage according to the comparison result.

7. The WDM receiver of claim 6, wherein the temperature controller, in the second mode, is configured to increase the heater voltage if the monitoring voltage increases when the heater voltage is increased, and decrease the heater voltage if the monitoring voltage decreases when the heater voltage is increased.

8. The WDM receiver of claim 6, wherein the temperature controller, in the second mode, is configured to decrease the heater voltage if the monitoring voltage increases when the heater voltage is decreased, and increase the heater voltage if the monitoring voltage decreases when the heater voltage is decreased.

9. A method for operating a WDM receiver based on a ring resonator, wherein the ring resonator-based WDM receiver comprising:
a plurality of ring resonator filters configured to receive a multi-wavelength optical signal and each configured to have a heater;
a plurality of photodetectors each configured to be connected to an output of each of the plurality of ring resonator filters and convert the optical signal into a current;
a plurality of transimpedance amplifying circuits each configured to be connected to an output of each of the plurality of photodetectors; and
a temperature controller configured to obtain a monitoring voltage corresponding to an output current of corresponding photodetector from each of the plurality of transimpedance amplifying circuits, and control a heater voltage of each of the plurality of ring resonator filters according to the monitoring voltage, and
wherein the method comprising:
(a) obtaining the heater voltages when peaks of the monitoring voltages are generated while sweeping the heater voltage of one of the plurality of ring resonator filters in a first mode; and
(b) adjusting the corresponding heater voltage depending on the corresponding monitoring voltage while changing the corresponding heater voltage based on each obtained heater voltages for each of the remaining ring resonator filters in a second mode.

10. The method of claim 9, wherein the monitoring voltage is configured to correspond to a DC component of the output current.

11. The method of claim 10, wherein each of the transimpedance amplifying circuits includes a DC offset-compensating circuit configured to compensate for a DC offset of a transimpedance amplifier, and the monitoring voltage is obtained from the DC offset-compensating circuit.

12. The method of claim 11, wherein the monitoring voltage is obtained by detecting an output of an operational amplifier provided in the DC offset-compensating circuit.

13. The method of claim 10, wherein the step (b) include:
changing the heater voltage, and comparing the monitoring voltage before and after the change, and increasing or decreasing the heater voltage according to the comparison result.

14. The method of claim 13, wherein the step (b) includes:
increasing the heater voltage if the monitoring voltage increases when the heater voltage is increased, and
decreasing the heater voltage if the monitoring voltage decreases when the heater voltage is increased.

15. The method of claim 13, wherein the step (b) includes:
decreasing the heater voltage if the monitoring voltage increases when the heater voltage is decreased, and
increasing the heater voltage if the monitoring voltage decreases when the heater voltage is decreased.

16. A WDM transmitter based on a ring resonator, comprising:
a plurality of optical modulators configured to output a WDM optical signal and each configured to have a heater;
a plurality of photodetectors each configured to be connected to an output of each of the plurality of optical modulators and convert the optical signal into a current;
a plurality of optical modulator drivers each configured to be connected to an input of each of the plurality of photodetectors; and
a temperature controller configured to obtain a monitoring voltage corresponding to an output current of the photodetector and control a heater voltage of the heater of each of the plurality of optical modulators according to the monitoring voltage.

17. The WDM transmitter of claim 16, wherein the temperature controller is configured to:
obtain the heater voltages when peaks of the monitoring voltages are generated while sweeping the heater voltages of the plurality of optical modulators in a first mode, and
adjust the corresponding heater voltage depending on the corresponding monitoring voltage while changing the corresponding heater voltage based on each obtained heater voltage for each of the optical modulators in a second mode.

18. The WDM transmitter of claim 17, wherein the temperature controller, in the second mode, is configured to change the heater voltage, and compare the monitoring voltage before and after the change, and increase or decrease the heater voltage according to the comparison result.

19. The WDM transmitter of claim 18, wherein the temperature controller, in the second mode, is configured to increase the heater voltage if the monitoring voltage increases when the heater voltage is increased, and decrease the heater voltage if the monitoring voltage decreases when the heater voltage is increased.

20. The WDM transmitter of claim 18, wherein the temperature controller, in the second mode, is configured to decrease the heater voltage if the monitoring voltage increases when the heater voltage is decreased, and increase the heater voltage if the monitoring voltage decreases when the heater voltage is decreased.
